(19) United States
(12) Patent Application Publication
(10) Pub. No.: US 2010/0095376 A1
(43) Pub. Date: Apr. 15, 2010

(54) SOFTWARE WATERMARKING

(76) Inventors: Tony F. Rodriguez, Portland, OR (US); Brian T. MacIntosh, Lake Oswego, OR (US); Ammon E. Gustafson, Portland, OR (US)

Correspondence Address: DIGIMARC CORPORATION, 9405 SW GEMINI DRIVE, BEAVERTON, OR, 97008, US

(21) Appl. No.: 12/398,948

(22) Filed: Mar. 5, 2009

Related U.S. Application Data
(60) Provisional application No. 61/034,850, filed on Mar. 7, 2008.

(51) Int. Cl. G06F 21/00; G06F 9/46

(52) U.S. Cl. 726/22; 718/100

(57) ABSTRACT

Various techniques for uniquely marking software, such as by reference to hidden information or other telltale features, are detailed. Some marks are evident in static code. Others are observable when the code is executed. Some do not manifest themselves until the code is exercised with specific stimulus. Different of the techniques are applicable to source code, object code, and firmware. A great number of other features and arrangements are also disclosed.

### RELATED APPLICATION DATA

This application claims priority to provisional application 61/034,850, filed Mar. 7, 2008, the disclosure of which is incorporated herein by reference.

### SPECIFICATION

The present technology concerns marking technology, e.g., as applied to computer code and hardware.

Digital watermarking (sometimes referred to as steganography) is known, e.g., from the present assignee's U.S. Pat. Nos. 6,122,403, 6,614,914, and 6,947,571. Similar information-hiding concepts can be applied in various software engineering disciplines, including code optimization, compiler behaviors, and platform architectures.

Many such approaches result in the association of a hidden identifier with particular instances of software, or hardware. The identifier may be discerned—to those persons or processes who know how it is hidden—by inspecting static code or hardware, or by monitoring some aspect of the code's execution or other operation. (The hidden information need not be an identifier; essentially any type of information can be hidden using these techniques.)

The present disclosure generally uses the terminology “watermarking.” However, such technology is sometimes referenced using other names, e.g., embedding a fingerprint or signature in code, secret code marking, etc.

For expository convenience, the following discussion is cast in terms of watermarking software. (Software can include all manner of computer code—including source and object code, firmware that may be embodied in hardware, etc.) It should be understood, however, that these principles likewise find application in connection with hardware.

Related work is detailed in patent documents U.S. Pat. Nos. 5,287,407, 5,559,884, 7,051,028, 7,236,610, 7,231,524, 20020112171, 20030023856, 20030217280, 2003217280, 20040044894, 20040202324, 20050066181, 20050105761, 20050183072, 2005021966, 2005055312, 20050262490, 20060010430, 20060200672, 20060277530, 20060123237, 20060136875, 20070234070 and WO9964973, and in the following writings:

Anckaert et al, “Steganography for Executables and Code Transformation Signatures,” Proc. 7^{th} Annual Conf. on Information Security and Cryptology, ICISC 2004, 2005, pp. 431-445.

Collberg et al, “Dynamic Path-Based Software Watermarking,” Proc. on Programming Language Design and Implementation, ACM SIGPLAN 2004, pp. 107-118.

Collberg et al, “Software Watermarking: Models and Dynamic Embeddings,” Conference Record of POPL '99: The 26th ACM SIGPLAN-SIGACT Symposium on Principles of Programming Languages, January, 1999, pp. 311-324.

Collberg et al, “UWStego: A General Architecture for Software Watermarking,” Technical Report, Computer Science Dept., University of Wisconsin, 2001, 35 pp.

Collberg et al, “Watermarking, Tamper-Proofing, and Obfuscation—Tools for Software Protection,” IEEE Trans. on Software Engineering, Vol. 28, No. 8, August, 2002, pp. 735-746.

Cousot et al, “An Abstract Interpretation-Based Framework for Software Watermarking,” 31st ACM SIGACT-SIGMOD-SIGART Symposium on Principles of Programming Languages, 2004, pp. 173-185.

El-Khalil et al, “Hydan: Hiding Information in Program Binaries,” Proc. 6^{th} International Conf. on Information and Communications Security, ICICS, 2004, pp. 187-199.

Hachez, “A Comparative Study of Software Protection Tools Suited for E-Commerce with Contributions to Software Watermarking and Smart Cards,” Thesis submitted to Belgian Catholic University, UCL, March 2003, 159 p.

Myles et al, “Software Watermarking Through Register Allocation: Implementation, Analysis, and Attacks,” Information Security and Cryptology—ICISC 2003: 6th International Conference, Seoul, Korea, Nov. 27-28, 2003, pp. 274-293.

Nagra et al, “A Functional Taxonomy for Software Watermarking,” Proc. of the Twenty-Fifth Australasian Computer Science Conference, Australian Computer Society Inc., 2002, pp. 177-186.

Palsberg, “Experience with Software Watermarking,” Proc. of ASCAC '00, 16^{th} Annual Computer Security Applications Conference, pp. 308-316, 2000.

Stern, et al, “Robust Object Watermarking: Application to Code,” in Pfitzmann, editor, Information Hiding '99, volume 1768 of Lectures Notes in Computer Science (LNCS), pages 368-378, Dresden, Germany, 2000. Springer-Verlag.

Thaker, Software Watermarking via Assembly Code Transformations, MS Thesis, San Jose State University, May, 2004, 69 pp.

Venkatesan et al, “A Graph Theoretic Approach to Software Watermarking,” Proc. Information Hiding: 4th International Workshop, IHW 2001, Pittsburgh, Pa., Apr. 25-27, 2001, pp. 157-168.

In view of the foregoing work already available to artisans in the field, this specification does not dwell on implementation details of the sort that are readily available from such prior writings, or that are otherwise routine to artisans in the field. Instead, this specification concentrates on novel concepts which can readily deployed by those skilled in the art, in view of such prior teachings.

To provide some structure to the disclosure (but without limiting the interpretation thereof), this specification generally classifies the disclosed technologies based on the state at which the watermark is read from the executable, or what type of mark (signature) is created. Four classes are employed: Static, Dynamic, Dynamic with Specific Stimulus, or Fingerprint. (No limitation should be inferred, however, from this organizational expedient.)

Techniques in the Static class generally act by examining static code for the presence of the watermark. These techniques may, or may not, be blind. (Non-blind approaches generally require reference to an un-watermarked original and/or the embedded watermark, in determining the presence of a watermark.)

Dynamic techniques typically involve instrumenting the platform on which code executes, and observing the behavior of the code during execution.

Dynamic with specific stimulus is similar to Dynamic, but generally requires a specific stimulus to generate a correct observable response.

Finally, Fingerprint techniques are most commonly (but not exclusively) used to uniquely identify a binary.

As will become apparent, some technologies occasionally bridge between different of these classes.

### Static

One static technique is to insert instructions in the code, with a pattern or placement that serves to uniquely mark the code. No-Ops, Jumps, Push/Pops, null Moves, etc., may be used for this purpose.

Here, as elsewhere, the mark can convey an arbitrary plural-bit payload message, or may simply comprise a characterizing feature—without an explicit message counterpart.

Consider a software company that wants to serialize particular copies of software, distributed to customers. Each copy may be marked, with a series of NOPS interspersed with other instructions in the assembly code, so as to encode the receiving customer's name or telephone number.

In one particular arrangement, the customer's name may be represented as a series of 8-bit ASCII symbols. Each “1” bit in the sequence may be represented by a NOP instruction; each “0” bit may be represented by a MOV instruction having the same source and destination. This sequence can be inserted into the object code at a location known to the software company.

If a copy of the marked software is found posted on a public web site (e.g., a software piracy, or warez, site), the company can disassemble the executable code and examine the series of NOP/MOV instructions, beginning at the known location, and thereby identify the customer from whom the copy leaked. Yet casual examination of the code (e.g., searching for the customer's name as a text string) finds nothing.

Naturally, the arrangement just-described is elementary, and would be relatively conspicuous to a savvy hacker. However, more obscure encoding techniques can be employed to advantageous effect.

For example, obfuscation may be increased by avoiding a conspicuously long series of inserted NOP/MOV instructions. One alternative arrangement takes the identifier-to-be-embedded, scrambles it (incrementing each ASCII value by 1 is a simple scrambling technique), and then pushes/pops each incremented-ASCII byte, in turn, on the stack. Such push/pop instructions can be scattered throughout the code—preceded by a marker instruction (any instruction which doesn't impair intended functionality of the program) that signals—to the software owner—that the following push/pop instructions represent a next bit of the identifier. (Much more sophisticated and/or subtle marking strategies can naturally be employed.) To recover the identifier, the code is searched for the marker instructions followed by push/pops. The corresponding values are collected from the push/pops, and unscrambled/combined to yield the encoded identifier.

It is not necessary for the software company to mark the software with a particular identifier prior to its distribution. Instead, the software can be arranged so that the serialization is effected at a later time, e.g., when the software is installed on a customer's computer. For example, part of the installation software may examine the host computer and collect information that identifies the computer and/or the user, e.g., a MAC address (a unique identifier attached to most network-capable devices), a user login, an IP address, etc. Or combinations of such identifiers may be used. The installation software can then modify the software being stored on the user's hard disk so as to encode such identifier data (e.g., by a series of NOP/MOV instructions as disclosed herein). Again, the result is a unique instance of the software, but with no change in function.

While the foregoing approach employed inserted instructions unrelated to the software's functionality, another approach takes existing software instructions and modifies them so as to encode the customer identifier. That is, sequences of code can be altered in manners that preserve their functionality (or equivalent code can be substituted), yet the alteration serves to make the code unique. Such code substitution or code transformation techniques can naturally be combined with the code insertion techniques discussed above.

One such technique exploits the flexibility inherent in IF statements. Negating the argument of IF logic, for example, allows the THEN and ELSE code to be switched. Thus, e.g., the logic IF A>5, JMP 5, RET is equivalent to IF A≦5, RET, JMP 5. A bit of data can be represented by the particular expression used. For example, if the THEN and ELSE instructions are in alphabetical order (e.g., JMP followed by RET), a “1” may be represented. If they are in reverse-alphabetical order (e.g., RET followed by JMP), a “0” may be represented. From an ordered sequence of such instructions (e.g., with the ordering determined by memory location), a multi-bit identifier can be encoded.

Imagine that the software author wants to encode a customer's particular 64-bit identifier. This identifier can be provided, e.g., to a PERL script, which then parses the originally-written source code (e.g., in C), and alters the logic of certain branches so as to flip the alphabetic ordering of the THEN and ELSE instructions as necessary to yield the desired payload representation.

As noted, the uniqueness that is imparted to software through the techniques disclosed herein can be a particular identifier, but it need not be. The uniqueness can alternatively be a characterizing feature—without an explicit message counterpart (this is sometimes termed a “fingerprint”). Thus, for example, the number of Jump, Compare, XOR and Pop instructions in code (or their respective percentages of all instructions) can comprise a 4-dimensional vector that can be used to distinguish that instance of code from any other. Again, such metric can be varied between instances of functionally-equivalent software by the arrangements disclosed herein.

Another static approach is based on register scheduling. Software typically employs a set of registers for use in local functions. The programmer can specify atypical registers, and unusual orders of register use. Data can be swapped between registers (e.g., R2 and R5). A tree of register usage can be created. Arbitrary data can thereby be encoded in the pattern of register usage.

This approach is especially useful in RISC cores and embedded processor environments, where the coder typically has more registers to work with, and exercises more control over the particulars of their use (as contrasted, e.g., with X-86 architectures). In X86 environments, coders have only 4 registers; in RISC environments, coders typically have 16 or 32. Register usage is readily tailored from the source code level—users commonly assign registers to local variables, and specification of which variables map to which registers is in user control.

Consider storage of static values. The static values used in a routine may be of different types, e.g., integers and floating points. The assignment of respective types of static values to different registers is inconsequential from an execution standpoint. An eight-bit watermark can be encoded by the pattern of data types stored in eight particular registers (e.g., R0-R7). An integer data type may represent a “1,” and a floating point data type may represent a “0.” A desired watermark can be input, e.g., to a PERL script, which can then run through and customize code so that the order of register usage serves to encode a desired eight-bit watermark. If there are not enough static values of a desired type used in a particular routine, dummy values can be used. If a routine's register usage is great enough that padding with dummy values isn't practical, a flag signal can be encoded in the register—signifying that no watermark is conveyed. (Such a flag signal can be any sequence of register usages that doesn't map to a valid watermark representation.)

Here, as in other techniques, such changes to existing or usual software designs can be made by a suitably configured compiler, or PERL script, or to a programmer.

Just as changes can be made to register usage, changes can similarly be made within object file formats. Headers, for example, convey data that often can be reordered and/or rearranged without affecting operation of the program. Headers can be swapped at the object level, particularly with knowledge about PE format.

The PE (portable executable) file format is a data structure commonly used with dynamic link libraries, object code, and other executables, which additionally serves to convey information needed by the operating system loader to manage the contained code (e.g., determining DLL references, establishing API import and export tables, resource management data, etc.). Such a file includes a number of headers and sections which tell the dynamic linker how to map the file contents into memory, and how to prepare the code for execution (e.g., setting pointers and loading registers). (For a good introduction to PE files, see Pietrek, An In-Depth Look into the Win32 Portable Executable File Format, Parts I and II, MSDN Magazine, February and March, 2002.)

In use, the loader examines the headers to determine what part of the file comprises static values, what part comprises code, etc. It copies the data portions (e.g., variables and statics) into memory, and stores the starting address in the DS (Data Segment) register. Likewise with the executable portion, and the CS (Code Segment) register.

The order that information is presented in the PE is largely arbitrary. The order can be set, or arranged, to encode a desired payload.

Consider the data portions of a PE file. The loader may merge them all into a data segment of memory—in an order dependent on their order of reference within the PE file headers. If a program includes the data structure definitions {date=day,month} and {time=minute,second}, the order of these definitions with the PE file is of no import. Yet the order can be used to encode bits of a hidden message.

In one particular arrangement, elements detailed in one or more PE headers are sorted alphabetically. The order of their listing in the PE file then moves forward and backward through this list, in accordance with “1” and “0” bits of a desired payload. For example, the first element listed in the PE file can be the one from the middle of the sorted list. To encode a “1”, the next one to be listed in the PE file is the next un-used one toward the end of the alphabet. To encode a “0,” the next one to be listed is the next un-used one towards the beginning of the alphabet. Etc.

Once the executable is loaded, the memory can be inspected to determine the order in which these elements have been processed (e.g., are listed in memory), and the hidden payload can thereby be discerned.

Portable executable files typically include certain standardized sections (e.g., a “.text” section and a “.data” section). However, the user is also able to define customized sections, through use of the #pragma code_seg and #pragma data_seg macros available in Microsoft compilers. Such customized sections can also be employed as symbols to encode hidden messages, e.g., by their presence or order.

Another vehicle to hide data in an executable is by data in a string table, or an INIT table. Either the content or organization of such table can be employed to convey hidden information.

String tables commonly hold text such as error messages. An executable may recognize 20 different errors, and present each with a corresponding text message. However, the table dedicated to this purpose may have more than 20 entries—with additional entries serving to convey additional information. The compiler faithfully copies this additional information into memory together with the error message texts, but the additional information is never presented to the user as a text message. Yet a forensic check of the loaded software can reveal its presence.

Alternatively, the order of the bona fide text messages can be crafted to convey hidden information. Again, an alpha-sort encoding, as discussed above, can be employed, with each successive bit of the payload represented by whether each successive next entry in the table alphabetically follows, or precedes, the one before.

INIT tables, which convey initialized variables, can be used in similar fashion. Or, as in the register usage case above, the order in which different data types appear can be used to represent hidden information.

As before, such tables can be hand-encoded, or the necessary tailoring to encode hidden information can be effected by the loader, the operating system, a PERL or other script, etc.

Yet another approach to software marking takes advantage of the pliable “edges” of code functions. For example, most routines in Intel binaries have multiple return statements, or dead space between functions. These can be deliberately crafted to provide hallmarks by which the code can be identified.

For reasons of performance, when a processor loads a PE file, it usually tries to align code fragments (e.g., subroutines) on double-word (D word) memory addresses (typically at intervals of 32 bits). Such alignment commonly leaves some unused memory gaps between code segments. There may be thousands of such fragments, and gaps, in memory at any time. This dead space can be utilized for code marking, e.g., by insertion of multiple returns, NOPs, or INT3 statements (if in debug). A compiler can be configured to insert such code marks.

Virtual tables also provide an avenue for software marking. For example, the C++ virtual tables that are generated at time of compilation can be designed—by the compiler—to present data in a characteristic manner that serves to uniquely identify the software.

Other changes to the object file, and/or to the loader, can also be made to effect static watermarking. For example, a loader can tailor the way code is loaded to impart a unique attribute, without impacting performance (e.g., not interfering with desired alignment). For example, a loader may be written that loads code in a manner that is dependent on (and may encode) a particular device's MAC address. The loader may further impart a unique watermark each time the binary is loaded.

Likewise, initialization tables may be tailored to identify the code. This may be done, for example, by adjusting values (or inserting spurious values), or ensuring that values occur in a certain order.

The startup section, e.g., of a runtime library, may be rewritten to effect watermarking. For example, if particular startup code is statically linked in, the particulars of the linking may be selected to serve as a software watermark.

### Dynamic

Thermal behaviors of a system can serve as a watermark. Increasingly, semiconductor devices are equipped with sensors by which their operating temperature can be tracked. The thermal signature produced by such a sensor over time—as the device executes a particular binary—can serve to identify that binary. The thermal signature can be tailored by turning on and off different functional units within the device during the course of execution. Suitable monitoring of the appropriate device pin(s) yields the signature signal.

Cache performance also provides opportunities to watermark software. Spurious cache hits or misses can be engineered into a program's execution for this purpose.

Instruction caches—as well as data caches—can be used for this purpose. (Instruction cache misses can be easier to instigate than data cache misses.)

Vector instruction sets, e.g., as used in MMX, SSE2, AltiVec, etc., have their own state machines and penalty states—all of which can be tailored and monitored to uniquely identify particular software.

Dynamic branch statistics provide another metric by which uniqueness of a particular executable can be established. Starting with the Pentium family, there is a 256 bit branch history that the processor keeps to predict how branches will be taken next time through. This register history provides data that can serve to identify particular software, and can be tailored to affect the branch behavior.

Interrupts can also be used to uniquely identify particular software.

A system's messaging architecture provides numerous opportunities for watermarking. For example, a secondary thread can be implemented within a primary process to watch message traffic, and dispatch messages as required to regulate/control desired characteristics (e.g., frequency, to bump up to next prime or multiple of seven, etc.).

SPY++ (a tool provided with Microsoft's Visual Studio) can be used as a reading mechanism. A symbol table can be created of code functionality—changing the way messages are put out. In SPY++ one can change the probability of message detection—which allows monitoring Windows messages for a system, or for applications.

System calls are another vehicle for software watermarking. For example, file system I/O calls can change control logic in code—a dance between two processes. Code in the binary does nothing unless instigated by another covert channel, e.g., triggered by delays in disk I/O system calls. An external view would suggest that the delay is due, e.g., to thermal recalibration, but it is actually deliberate.

The GUIDs (Global Unique Identifiers) used by an operating system to identify components can be watermarked, e.g., based on MAC address and/or timestamp, etc. Alternatively, the GUIDs can be used as a covert channel (each typically conveys 128 bits).

Viral techniques can also be used to advantageous effect. A benign virus can be deployed to embed binaries with watermarks, or with watermark-generating capabilities. Such an approach can be used to cause an existing binary to alter its behavior by covertly patching it to exhibit a specific behavior. (Care must be taken, of course, so that the covert channel employed by the virus for a watermark is difficult to find/remove. In some cases, the virus should be crafted so that the file size is kept the same.)

Intel publishes a software tool, VTune, that is used by software engineers to optimize software performance. This tool gathers a large variety of information, including cache and all other processor state information, and can be used to detect the presence of conditions and behaviors that serve as dynamic watermarks. For example, VTune can monitor a behavior or attribute associated with code execution, and consult reference data (e.g., in a table or database) to determine whether that monitored behavior/attribute corresponds to a dynamic software watermark.

### Dynamic, Specific Stimulus

During execution, code can operate in a challenge/response arrangement, generating challenges to which software on the machine (perhaps another program) must respond with correct responses.

Such an arrangement can be deployed in a manner similar to a hardware key lock dongle. Just as software periodically interrupts to check the presence of a hardware dongle, it can interrupt and issue a challenge. If the expected response is not forthcoming, it stops execution.

This may be done with covert channels. This can also help deal with attack. For example, if a logic analyzer is running, code that is doing the checking may be disabled.

As will be apparent, many of the techniques reviewed earlier can be also implemented to respond in a characteristic manner to a specific stimulus, if desired.

### Fingerprint

Software may be analyzed to discern tell-tale traits associated with particular compilers. Thus, an executable might have characteristics indicating it was generated by X version of Y compiler. Compilers may be configured to leave particular such tell-tale traits in their compiled code.

### Concluding Remarks

About watermark payloads, it will be recognized that their length is arbitrary. The payload can be one or a few bits (e.g., 4 or 8) or a large number (e.g., 128 or 1024), etc. Moreover, various encoding techniques splay a watermark message payload into a longer series of bit, e.g., for purposes of increasing robustness, error correction, or other purposes. Such arrangements are detailed in commonly-owned U.S. Pat. No. 6,614,914.

Years ago, software watermarking had relatively limited practicality, due to the relatively limited options that then-existing platforms and architectures presented. In the ensuing years, however, system complexity has increased exponentially, and with it have come myriad opportunities for covert channel marking and communication. (Compare, e.g., the Intel 4004—with its dedicated circuitry and 1K of instruction memory—with the massively chaotic arrangements now in commonplace use, e.g., X86 interpreter-based systems, with their complex register usages, caches, noise, etc.) As levels of abstraction increased, so did degrees of freedom and noise that make widespread watermarking possible. This trend will likely continue—allowing the techniques referenced herein to be still more widely deployed.

(Microcode in these advanced processors that emulates X86 architecture may be modified so that only binaries having certain (serialized) properties can run on certain processors.)

To provide a comprehensive disclosure without unduly lengthening this specification, applicants incorporate by reference the documents referenced above. It is expressly contemplated that the teachings of such documents be employed by artisans in implementing and modifying our own novel contributions to the field. Similarly, applicants intend, and expressly instruct, that the techniques detailed herein be employed in conjunction with the techniques disclosed in the incorporated references

We claim:

1. A method of executing program code on a hardware system, the method including the acts: monitoring program execution using tracking software that assesses a behavior associated with program execution, and then consulting reference data to determine whether said monitored behavior corresponds to a dynamic software watermark.

2. A method of executing software on a hardware system, the method including the acts: collecting thermal information from said system, and checking said collected information for correspondence with a thermal profile associated with particular software.

3. A method for uniquely identifying an instance of program code, by reference to an order of plural items therein, the items being sortable into a first order ranging from an initial item at a starting end of the order, to a last item at a final end of the order, the method comprising the acts:
(a) receiving a plural-bit payload, comprising ones and zeroes;
(b) identifying an item from an intermediate position in the first order, and assigning it to an end position in a new order; and
(c) arranging other of said items in subsequent positions of the new order so that the new order encodes the plural-bit payload.

4. The method of claim 3 wherein the items comprise data items in a PE (portable executable) file format.

5. The method of claim 3 wherein the items comprise registers referenced in the program code.

6. The method of claim 3 wherein the items comprise data in a string table.

7. The method of claim 3 wherein the items comprise data in an INIT cable.

8. The method of claim 3 wherein the first order is alphabetical.

9. The method of claim 3 wherein the arranging is performed by a processor executing a script.

10. The method of claim 3 in which (c) comprises successively choosing different ones of the items from the first order in accordance with values of successive bits of the plural bit payload to yield the items in the new order.

11. The method of claim 10 that includes:
selecting, as a next item for the new order, an item from a position towards the starting end of the first order from said intermediate position, if a bit of the plural-bit payload has a value of one; else selecting an item towards the final end of the first order from said intermediate position; and
repeating the aforesaid act for subsequent items in accordance with subsequent values of bits in the plural-bit payload.

12. The method of claim 3 that includes analyzing the new order of items to discern the plural-bit payload encoded thereby.
